(19) United States
(12) Patent Application Publication
(10) Pub. No.: US 2002/0193161 A1
(43) Pub. Date: Dec. 19, 2002

(54) Game system, program and image generation method

(76) Inventor: Katsuhiro Ishii, Kanagawa-ken (JP)

Correspondence Address: Oliff & Berridge, PO Box 19928, Alexandria, VA, 22320, US

(21) Appl. No.: 09/937,082

(22) PCT Filed: Jan. 23, 2001
(86) PCT No.: PCT/JP01/00407

(30) Foreign Application Priority Data
Jan. 25, 2000 (JP) 2000-15228

(51) Int. Cl. A63F 13/00

(52) U.S. Cl. 463/30

(57) ABSTRACT

A game system, program and image generation method can generate a realistic image with reduced processing load. An image of a geometry-processed object OB is temporarily drawn in an intermediate buffer and then drawn in a frame buffer. A primitive surface PS, of which drawing position DP is specified based on the three-dimensional information of the object OB and on which the image of the intermediate buffer is mapped, is drawn in the frame buffer. When a plurality of primitive surfaces corresponding to a plurality of objects are to be drawn in the frame buffer, the hidden-surface removal is performed based on the depth value of each of the primitive surfaces. A shadow is represented by drawing a plurality of primitive surfaces, of which drawing positions are specified based on the three-dimensional information of one object, into the frame buffer. After the image of the intermediate buffer has been subjected to an image effect processing or synthesized with the other image in the past frame, it is drawn in the frame buffer. The image of the geometry-processed object is drawn in the intermediate buffer for each of the discrete frames.

### TECHNICAL FIELD

The present invention relates to a game system, program and image generation method.

### BACKGROUND ART

There is known a game system which can generate an image viewable from a given viewpoint in an object space, that is, a virtual three-dimensional space. Such a game system is very popular as one that can cause a player or players to experience a so-called virtual reality. One of such game systems is for a flight simulator game. In the flight simulator game, a player aviates an airplane (or object) in the object space and enjoys the game by fighting or competing against an airplane aviated by another player or computer.

In such game systems, it is an important technical problem that more realistic images can be generated to improve the player's feel of virtual reality. It is thus desirable that even heat waves produced by the afterburner of an airplane can realistically be represented, for example.

In a sports game, a number of characters (or objects) come on the scene. If it is wanted to update all the characters in all the frames, another problem will be raised in that the processing load becomes vary heavy.

### DISCLOSURE OF THE INVENTION

In view of the aforementioned problems, an objective of the present invention is to provide a game system, program and image generation method which can generate more realistic images with reduced processing load.

To this end, the present invention provides a game system performing image generation, comprising: intermediate buffer drawing means which temporarily draws an image of a geometry-processed object in an intermediate buffer in place of drawing the image in a frame buffer; and frame buffer drawing means for drawing the image of the geometry-processed object drawn in the intermediate buffer from the intermediate buffer into the frame buffer. The present invention also provides a computer-usable information storage medium comprising a program for realizing the above-described means on a computer. The present invention further provides a computer-usable program (including a program embodied on a carrier wave) comprising a processing routine for realizing the above-described means on the computer.

According to the present invention, the image of the geometry-processed object is drawn in the intermediate buffer. The drawn image is then drawn in the frame buffer. Thus, the image in the intermediate buffer can be drawn in the frame buffer after it has been subjected to any image effect processing or to various image synthesizing processing. As a result, more realistic image can be generated with reduced processing load.

It is desirable that when the object image is to be drawn in the intermediate buffer, to use viewpoint information similar to that used on the drawing to the frame buffer.

When the object image is to be drawn in the intermediate buffer, it is further desirable that the image in the intermediate buffer is drawn at a drawing position (or drawing area) which is specified by the three-dimensional information of the object.

In the game system, information storage medium and program according to the present invention, into the frame buffer, the frame buffer drawing means may draw a primitive surface of which drawing positions is specified based on three-dimensional information of the object and on which the image of the geometry-processed object drawn in the intermediate buffer is texture-mapped.

Thus, the image of the intermediate buffer can be drawn in the frame buffer through a simplified process in which the image of the intermediate buffer is only texture-mapped on the primitive surfaces.

The three-dimensional information of the object may be that relating to the representative points in the object. The primitive surfaces may be free curved surfaces other than polygons.

In the game system, program and information storage medium according to the present invention, when a plurality of primitive surfaces corresponding to a plurality of objects are to be drawn into the frame buffer, the frame buffer drawing means may perform hidden-surface removal between the primitive surfaces based on the depth values of the respective primitive surfaces.

Thus, there can be avoided such a problem that the parts of a first object go through a second object.

The technique of hidden-surface removal maybe any of various techniques such as Z-buffer method, depth sorting method or the like. The depth value of each primitive surface can be specified by the drawing position thereof.

In the game system, program and information storage medium according to the present invention, the frame buffer drawing means may draw a plurality of primitive surfaces of which drawing positions are specified based on the three-dimensional information of one object into the frame buffer, and may make images texture-mapped over the plurality of primitive surfaces different from one another.

Thus, the shadow and other representations of the object can be realized with reduced processing load.

The technique of making the images texture-mapped over the plurality of primitive surfaces different from one another may be such a technique that a different color table of texture mapping is used to each primitive surfaces, for example.

The game system, program and information storage medium according to the present invention may further comprise means for performing a given image effect processing on the image on the intermediate buffer before the image drawn in the intermediate buffer is drawn in the frame buffer (or comprise a program or processing routine for realizing the means on a computer).

Thus, the image effect processing on the object image can be realized with reduced processing load.

The image effect processing is only necessary to transform at least the image in the intermediate buffer into any suitable form and may be any of various processings such as pixel exchange, pixel averaging, mosaic (tessellation) processing, shadow generating and so on.

The game system, program and information storage medium according to the present invention may further comprise means for synthesizing an image drawn in the intermediate buffer at a present frame with another image drawn in the intermediate buffer at a past frame before the image drawn in the intermediate buffer is drawn in the frame buffer (or comprise a program or processing routine for realizing the means on a computer).

Thus, an image can be generated while reflecting the images in the past frames. As a result, the representation of afterimage can be realized.

The game system, program and information storage medium according to the present invention may further comprise means for synthesizing an image drawn in the intermediate buffer with another image drawn in the frame buffer before the image drawn in the intermediate buffer is drawn in the frame buffer (or comprise a program or processing routine for realizing the means on a computer).

Thus, the object image can be synthesized, for example, with the background image. This improves the variety in the representation of image.

It is desirable that when the image in the frame buffer is to be drawn back to the intermediate buffer, the image portion drawn in the frame buffer within a given range of drawing is drawn back to the intermediate buffer.

In the game system, program and information storage medium according to the present invention, the intermediate buffer drawing means may draw the image of the geometry-processed object in the intermediate buffer for each discrete frame.

Thus, the geometry-processing on the object and the drawing to the intermediate buffer can be carried out for each of the discrete frames, highly reducing the processing load.

It is completely arbitrary at which frame the drawing to the intermediate buffer should be carried out. It is further desirable that the drawing of the image from the intermediate buffer to the frame buffer is performed for all the frames.

In the game system, program and information storage medium according to the present invention, when the images of plural geometry-processed objects are drawn in the intermediate buffer, the intermediate buffer drawing means may draw an image of the K-th object in the intermediate buffer at the N-th frame and may draw an image of the L-th object in the intermediate buffer at the (N+1)-th frame without drawing the image of the K-th object in the intermediate buffer.

Thus, it is not required to perform drawing to the intermediate buffer and geometry-processing on all of the plural objects coming on the scene for all the frames. As a result, the number of objects coming on the scene may be increased without significantly increasing the processing load.

It is further desirable that the K-th and L-th object images drawn in the intermediate buffer are drawn in the frame buffer at the (N+1)-th frame.

### BRIEF DESCRIPTION OF THE DRAWINGS

FIG. 1 is a block diagram of a game system according to this embodiment of the present invention.

FIG. 2 illustrates a technique of temporarily drawing the image of a geometry-processed object in the intermediate buffer before it is drawn from the intermediate buffer to the frame buffer.

FIG. 3 illustrates a technique of drawing, in the frame buffer, primitive surfaces over which the image of the intermediate buffer is texture-mapped.

FIG. 4 illustrates a technique of performing the hidden-surface removal based on the depth value in each of plural primitive surfaces corresponding to a plurality of objects when the primitive surfaces are to drawn in the frame buffer.

FIG. 5 illustrates a technique of representing the shadow of the object.

FIG. 6 illustrates a technique of drawing the image of the intermediate buffer in the frame buffer after it has been subjected to an image effect processing.

FIGS. 7A, 7B and 7C illustrate the pixel exchanging process which is one image effect processing.

FIGS. 8A and 8B illustrate the pixel averaging process which is another image effect processing.

FIG. 9 illustrates a technique of synthesizing the image saved in the intermediate buffer at the past frame with the image of the present frame.

FIG. 10 illustrates a technique of drawing the image from the frame buffer back to the intermediate buffer and synthesizing it with the image of the intermediate buffer.

FIG. 11 illustrates a technique of drawing the image of the intermediate buffer for each of the discrete frames.

FIG. 12 illustrates a technique of drawing a plurality of objects in the intermediate buffer.

FIG. 13 is a flowchart illustrating the details of the process according to this embodiment.

FIG. 14 is a flowchart illustrating the other details of the process according to this embodiment.

FIG. 15 shows a hardware structure in which this embodiment can be realized.

FIGS. 16A, 16B and 16C show various system forms to which this embodiment can be applied.

### BEST MODE FOR CARRYING OUT THE INVENTION

A preferred embodiment of the present invention will now be described with reference to the drawings.

1. Configuration

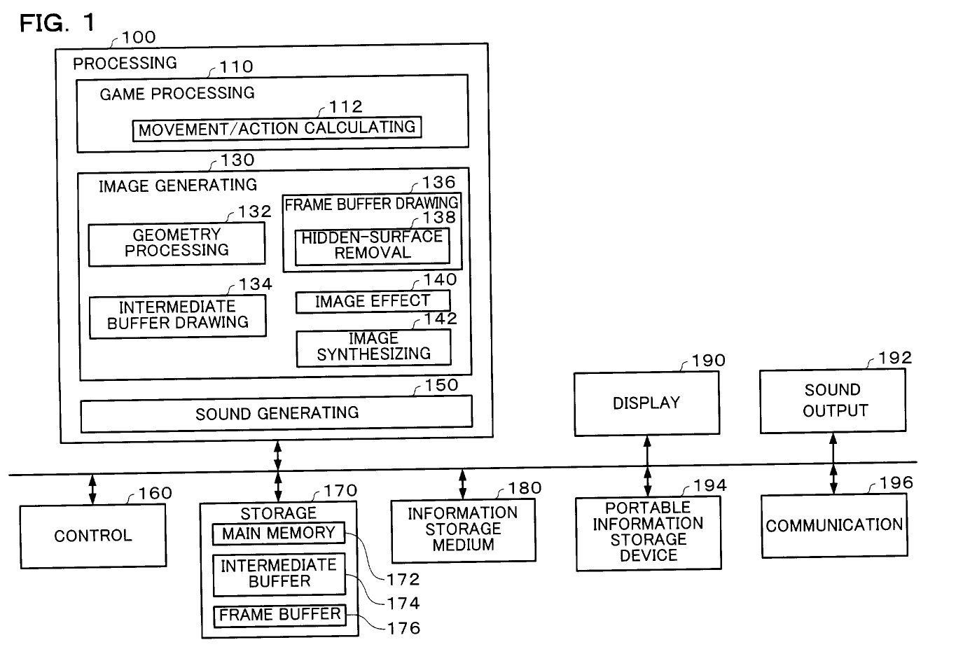

FIG. 1 shows a block diagram of a game system (or image generating system) according to this embodiment. In this figure, this embodiment may comprise at least a processing section 100 (or a processing section 100 with a storage section 170 or a processing section 100 with a storage section 170 and an information storage medium 180). Each of the other blocks (e.g., control section 160, display section 190, sound output section 192, portable information storage device 194 and communication section 196) may take any suitable form.

The processing section 100 is designed to perform various processings for control of the entire system, commands to the respective blocks in the system, game processing, image processing, sound processing and so on. The function thereof may be realized through any suitable hardware means such as various processors (CPU, DSP and so on) or ASIC (gate array or the like) or a given program (or game program).

The control section 160 is used to input operational data from the player and the function thereof may be realized through any suitable hardware means such as a lever, a button, a housing or the like.

The storage section 170 provides a working area for the processing section 100, communication section 196 and others. The function thereof may be realized by any suitable hardware means such as RAM or the like.

The information storage medium (which may be a computer-usable storage medium) 180 is designed to store information including programs, data and others. The function thereof may be realized through any suitable hardware means such as optical memory disk (CD or DVD), magneto-optical disk (MO), magnetic disk, hard disk, magnetic tape, memory (ROM) or the like. The processing section 100 performs various processings in the present invention (or this embodiment) based on the information that has been stored in this information storage medium 180. In other words, the information storage medium 180 stores various pieces of information (programs or data) for realizing (or executing) the means of the present invention (or this embodiment) which are particularly represented by the blocks included in the processing section 100.

Part or the whole of the information stored in the information storage medium 150 will be transferred to the storage section 170 when the system is initially powered on. The information stored in the information storage medium 180 may contain at least one of program code set for processing the present invention, image data, sound data, shape data of objects to be displayed, table data, list data, information for instructing the processings in the present invention, information for performing the processings according to these instructions and so on.

The display section 190 is to output an image generated according to this embodiment and the function thereof can be realized by any suitable hardware means such as CRT, LCD or HMD (Head-Mount Display).

The sound output section 192 is to output a sound generated according to this embodiment and the function thereof can be realized by any suitable hardware means such as speaker.

The portable information storage device 194 is to store the player's personal data and save data and may be take any suitable form such as memory card, portable game machine and so on.

The communication section 196 is designed to perform various controls for communication between the game system and any external device (e.g., host device or other image generating system) . The function thereof may be realized through any suitable hardware means such as various types of processors or communication ASIS or according to any suitable program.

The program or data for executing the means in the present invention (or this embodiment) may be delivered from an information storage medium included in a host device (or server) to the information storage medium 180 through a network and the communication section 196. The use of such an information storage medium in the hose device (or server) falls within the scope of the invention.

The processing section 100 further comprises a game processing section 110, an image generating section 130 and a sound generating section 150.

The game processing section 110 is designed to perform various processes such as coin (or charge) reception, setting of various modes, game proceeding, setting of scene selection, determination of the position and rotation angle (about X-, Y- or Z-axis) of an object (or each of one or more primitive surfaces), movement of the object (motion processing), determination of the view point (or virtual camera position) and visual line (or rotational virtual camera angle) , arrangement of the object within the object space, hit checking, computation of the game results (or scores) processing for causing a plurality of players to play in a common game space, various game computations including game-over and other processes, based on operational data from the control section 160 and according to the personal data, saved data and game program from the portable information storage device 194.

The game processing section 110 further comprises a movement/action calculating section 112.

The movement/action calculating section 112 is to calculate the information of movement for objects such as motorcars and so on (positional and rotation angle data) and the information of action for the objects (positional and rotation angle data relating to the parts in the objects). For example, the movement/action calculating section 112 may cause the objects to move and act based on the operational data inputted by the player through the control section 160 and according to the game program.

More particularly, the movement/action calculating section 112 may determine the position and rotational angle of the object, for example, for each one frame (1/60 seconds) . For example, it is now assumed that the position of the object for (k−1) frame is PMk−1, the velocity is VMk−1, the acceleration is Amk−1, time for one frame is Δt. Thus, the position PMk and velocity VMk of the object for k frame can be determined by the following formulas (1) and (2):

PMk=PMk−1+VMk−1×Δt (1)

VMk=VMk−1+Amk−1×Δt (2)

The image generating section 130 is designed to perform various image processings according to the instructions from the game processing section 110. For example, the image generating section 130 may generate an image viewable from a virtual camera (or viewpoint) in the object space and then output the generated image toward the display section 190. The sound generating section 150 is designed to perform various sound processings according to the instructions from the game processing section 110 for generating BGMs, sound effects, voices and the like and to output the generated sound toward the sound output section 192.

All the functions of the game processing section 110, image generating section 130 and sound generating section 150 may be realized through hardware or software. Alternatively, they may be realized through both hardware and software.

The image generating section 130 comprises a geometry processing section (or three-dimensional calculation section) 132, an intermediate buffer drawing section 134, a frame buffer drawing section 136, an image effect section 140 and an image synthesizing section 142.

The geometry processing section 132 is to perform various geometry-processings (or three-dimensional calculations) such as coordinate transformation, clipping, perspective transformation, light-source calculation and so on. Data relating to a geometry-processed (or perspective-transformed) object which include shape data such as the vertex coordinates of the object, vertex texture coordinates, brightness data and so on will be saved in a main memory 172 in the storage section 170.

The intermediate buffer drawing section 134 is to perform a processing in which the image of a geometry-processed (or perspective-transformed) object (e.g., flame or character) is temporarily drawn in an intermediate buffer 174 rather than in a frame buffer 176.

The frame buffer drawing section 136 is designed to draw the image of the geometry-processed object drawn in the intermediate buffer 174 in the frame buffer 176.

The drawing of the object into the frame buffer 176 can be realized, for example, by drawing primitive surfaces (polygons, free curved faces or the like) which are specified relating their drawing positions based on the three-dimensional information of the object and over which the image of the intermediate buffer 174 is texture-mapped, in the frame buffer 176.

The image of the geometry-processed object may be drawn in the intermediate buffer 174 for each of the discrete frames (e.g., one frame, four frames and seven frames) . Thus, the processing load can be reduced since the geometry-processing of the object can be carried out for each of the discrete frames.

The frame buffer drawing section 136 includes a hidden-surface removal section 138 which is designed to use a Z-buffer (or Z-plane) in which the Z-values (or depth values) have been stored and to perform the hidden-surface removal according to the algorithm of the Z-buffer method. However, the hidden-surface removal section 138 may perform the hidden-surface removal, for example, through a depth sorting (or Z-sorting) method in which the primitive surfaces are sorted depending on the distance spaced away from the viewpoint and drawn starting from a farthest primitive surface from the viewpoint.

If a plurality of primitive surfaces corresponding to a plurality of objects is to be drawn in the frame buffer, the hidden-surface removal section 138 also performs the hidden-surface removal between the primitive surfaces based on the Z-value (or depth value) of the respective primitive surfaces.

It is now assumed, for example, that the images of the first and second geometry-processed objects are drawn in the intermediate buffer 174 and that the first and second primitive surfaces over which the drawn images are texture-mapped are then drawn in the frame buffer 176. In such a case, the hidden-surface removal section 138 will perform the hidden-surface removal between the first and second primitive surfaces based on the Z-values thereof. Thus, such a defect that the parts of one object are viewable through the other object can be avoided.

The image effect section 140 is to perform various image effect processings (or image transformation processings) to the image on the intermediate buffer 174 before the latter is drawn in the frame buffer 176. If it is wanted to represent heat waves from the afterburner of an airplane, the image effect section 140 may perform an image effect processing such as the pixel exchanging process (or a process of exchanging color information for each pixel), the pixel averaging process (or a process of blending the color information of one pixel with those of the surrounding pixels) or the like. If the shadow of a character is to be generated, the image effect section 140 may exchange a color table now used to another color table for representing the shadow.

The image synthesizing section 142 is designed to synthesize an image drawn in the intermediate buffer 174 at a present frame with another image drawn in the intermediate buffer 174 at the past frame before the images drawn in the intermediate buffer 174 are drawn in the frame buffer 176 or to synthesize an image drawn in the intermediate buffer 174 with another image drawn in the frame buffer 176.

The game system of the present invention may be dedicated for a single-player mode in which only a single player can play the game or may have a multi-player mode in which a plurality of players can play the game.

If a plurality of players play the game, only a single terminal may be used to generate game images and sounds to be provided to all the players. Alternatively, a plurality of terminals interconnected through a network (transmission lien or communication line) may be used in the present invention.

2. Features of this Embodiment

2.1 Temporary Drawing to the Intermediate Buffer

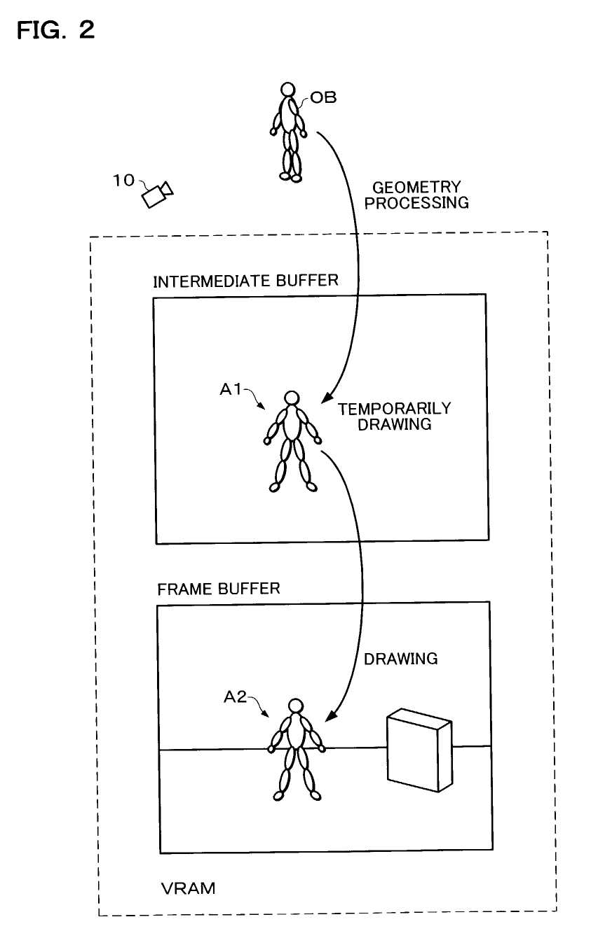

In this embodiment, as shown by A1 in FIG. 2, the image of a geometry-processed (or perspective-processed) object OB (or character) is temporarily drawn in the intermediate buffer rather than directly drawing in the frame buffer. Thereafter, as shown by A2 in FIG. 2, the image of the geometry-processed object OB drawn in the intermediate buffer is drawn in the frame buffer.

The intermediate buffer may be a buffer which is allocated, for example, on VRAM at an memory area other than that of the frame buffer. The image of the geometry-processed object OB is usually drawn directly in the frame buffer. In this embodiment, the image is drawn in the frame buffer after it has temporarily been drawn in the intermediate buffer.

Thus, there can be carried out various processes such as a process of subjecting the image on the intermediate buffer to an image effect processing and then drawing the effect-processed image in the frame buffer or a process of performing various image synthesizing processings on the intermediate buffer and then drawing the processed image on the frame buffer or a process of updating the images on the intermediate buffer for each frame rather than for all the frames.

The image of the object OB is drawn in the intermediate buffer using the viewpoint information (viewpoint position, visual-line angle or view angle) which is similar to that used on drawing it in the frame buffer. If the virtual camera (or viewpoint) 10 is located in front of the object OB, therefore, an image obtained as viewed from the front face of the object OB will be drawn in the intermediate buffer. On the contrary, if the virtual camera 10 is located by the side of the object OB, an image obtained as viewed from the side of the object OB will be drawn in the intermediate buffer. In such a manner, the geometry-processing will not be re-performed on drawing the image of the object OB from the intermediate buffer to the frame buffer. This reduces the processing load.

When the image of the object OB is to be drawn from the intermediate buffer to the frame buffer, that image will be drawn in a drawing position (or area) which is specified according to the three-dimensional information (position, rotational angle) of the object OB. More particularly, the image of the object OB will be drawn at a drawing position which is specified based on the representative three-dimensional information of the object OB.

2.2 Drawing to the Frame Buffer Using the Texture Mapping

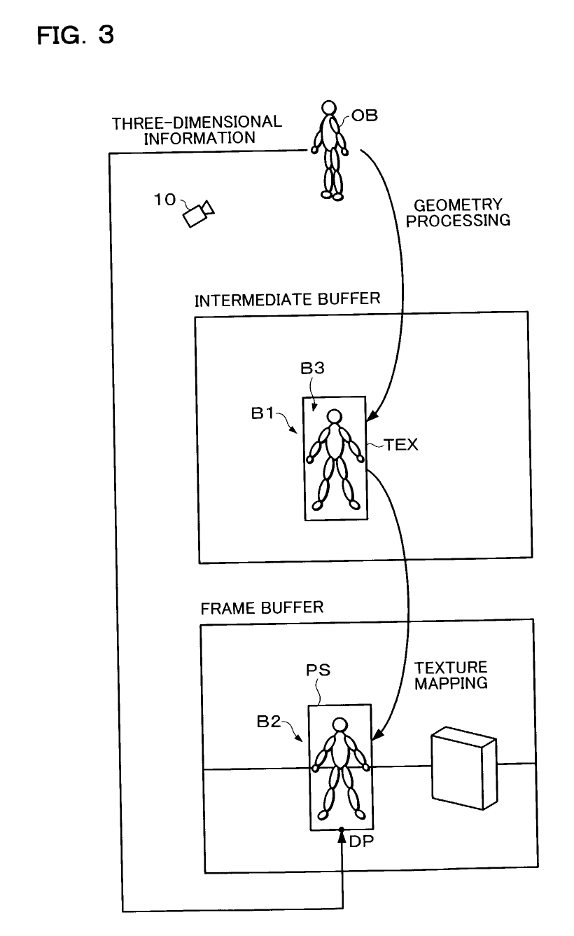

In this embodiment, as shown by B1 in FIG. 3, the image of the geometry-processed object is drawn in the intermediate buffer. The drawn image is then set as a texture TEX. As shown by B2 in FIG. 3, this texture TEX is then mapped on a primitive surface PS such as a polygon or free curved surface, which is in turn drawn in a drawing position DP specified according to the three-dimensional information of the object OB.

Thus, the image of the object OB can be drawn from the intermediate buffer to the frame buffer through a simple and less loading process in which the image of the intermediate buffer is only texture-mapped on the primitive surface PS. Since the primitive surface is drawn in the drawing position DP which is specified according to the three-dimensional information of the object OB, the perspective representation and hidden-surface removal can be realized appropriately.

When the image of the intermediate buffer is used as the texture TEX, it is desirable that the α-value has been set such that a portion shown by B3 in FIG. 3 (or a portion surrounding the object) becomes transparent. Thus, the portion shown by B3 in FIG. 3 will be made transparent on the frame buffer so that any image located behind this portion (e.g., background) can be viewed therethrough.

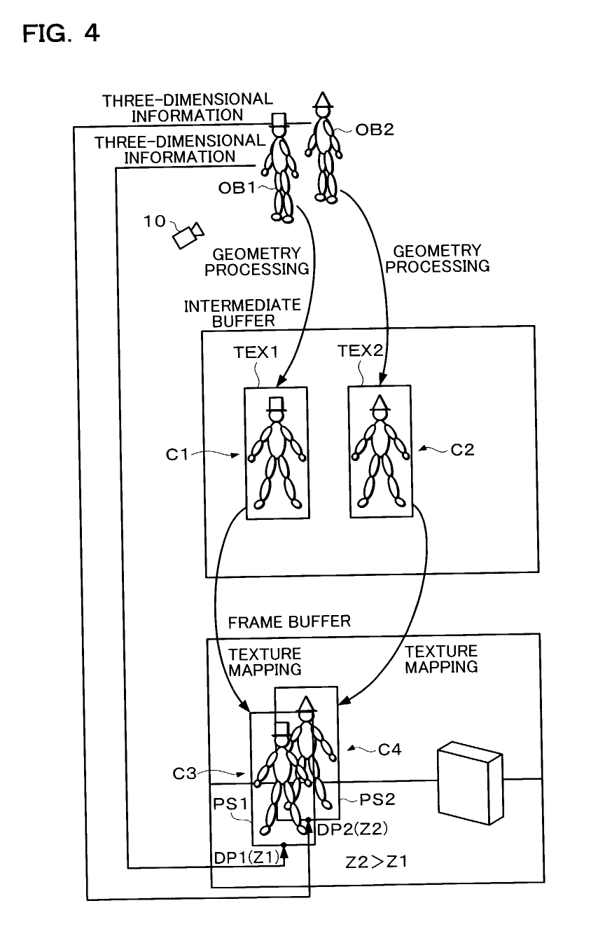

In this embodiment, when there are a plurality of objects OB1 and OB2 as shown in FIG. 4, the hidden-surface removal will be carried out through a technique which will be described below.

As shown by C1 and C2 in FIG. 4, the images of the geometry-processed objects OB1 and OB2 are drawn in the intermediate buffer. These drawn images are then set as textures TEX1 and TEX2. As shown by C3 and C4 in FIG. 4, these textures TEX1 and TEX2 are then mapped on primitive surfaces PS1 and PS2, respectively. These primitive surfaces PS1 and PS2 are then drawn respectively at drawing positions DP1 and DP2 which are specified according to the three-dimensional information of the objects OB1 and OB2, respectively. Next, the hidden-surface removal between the primitive surfaces PS1 and PS2 is carried out based on Z-values Z1 and Z2 included in the drawing positions DP1 and DP2, respectively. At C1 and C2 in FIG. 4, Z2 is larger than Z1. This means that the primitive surface PS2 is at a position deeper than the other primitive surface PS1. Therefore, the primitive surface PS2 will be subjected to the hidden-surface removal due to the primitive surface PS1. As a result, the image of the object OB2 will be viewed to be behind the image of the object OB1.

According to such a technique, an appropriate hidden-surface removal can be made which is reflected by the three-dimensional information of the objects OB1 and OB2. Since the images of the geometry-processed objects OB1 and OB2 are respectively mapped on the primitive surfaces PS1 and PS2, the three dimensional and perspective representations can be realized appropriately. According to this technique, furthermore, the primitive surfaces PS1 and PS2 are used as flat faces. Thus, there can be avoided such a defect that an arm extending from the object OB2 will pierce through the other object OB1. Therefore, this embodiment can generate a game image optimal to a game in which a number of moving objects come on the scene.

To represent the shadow of the object OB, this embodiment also takes another technique which will be described below.

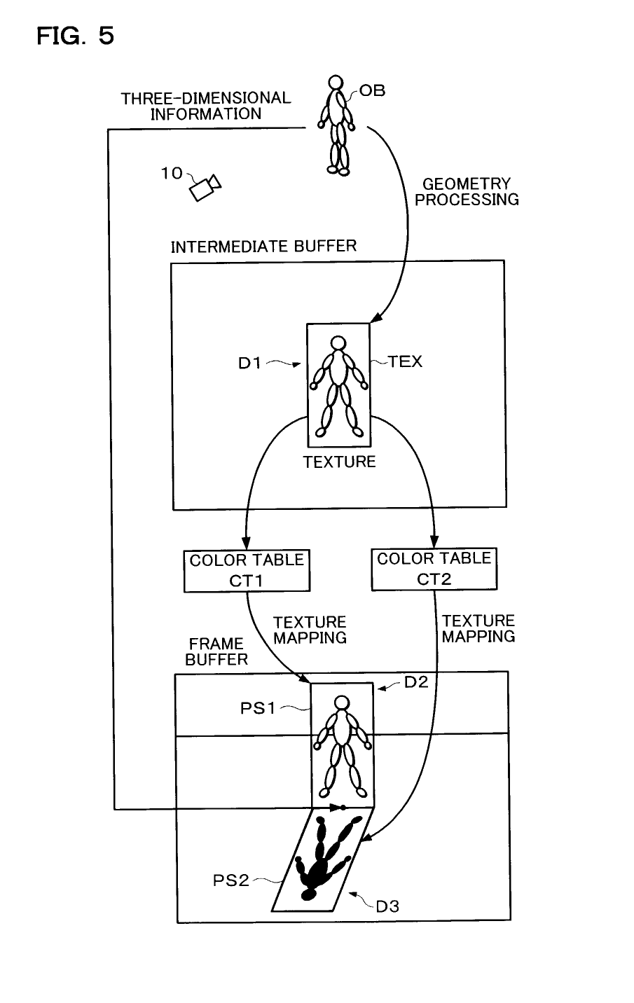

As shown by D1 in FIG. 5, the image of a geometry-processed object OB is drawn in the intermediate buffer and the drawn image is then set as a texture TEX. As shown by D2 and D3 in FIG. 5, a plurality of primitive surfaces PS1 and PS2 specified in drawing position according to the three-dimensional information of one object OB are then drawn in the frame buffer. At the same time, images to be texture-mapped on the primitive surfaces PS1 and PS2 are made different from each other.

More particularly, the texture TEX is mapped on the primitive surface PS1 using the normal color table CT1 (index color texture mapping). On the other hand, the texture TEX is mapped on the primitive surface PS2 using a shadow forming color table CT2 (or a color table in which the colors of all the index numbers are set to be substantially black).

In such a manner, the shadow of the object can be represented through a simple procedure in which the texture TEX is only mapped on the primitive surfaces PS1 and PS2 using the different color tables CT1 and CT2.

The primitive surface PS2 on which the texture of shadow is mapped may also be generated by reversing and back facing the primitive surface PS1. It is desirable that the shape of the primitive surface PS2 is variable (or slant deformed) depending on the position or direction of the light source.

2.3 Image Effect Processings

In this embodiment, various image effect processings are carried out to the image in the intermediate buffer before it is drawn in the frame buffer.

For example, if it is wanted to represent heat waves from the afterburner (flame) of an airplane, the following technique will be taken.

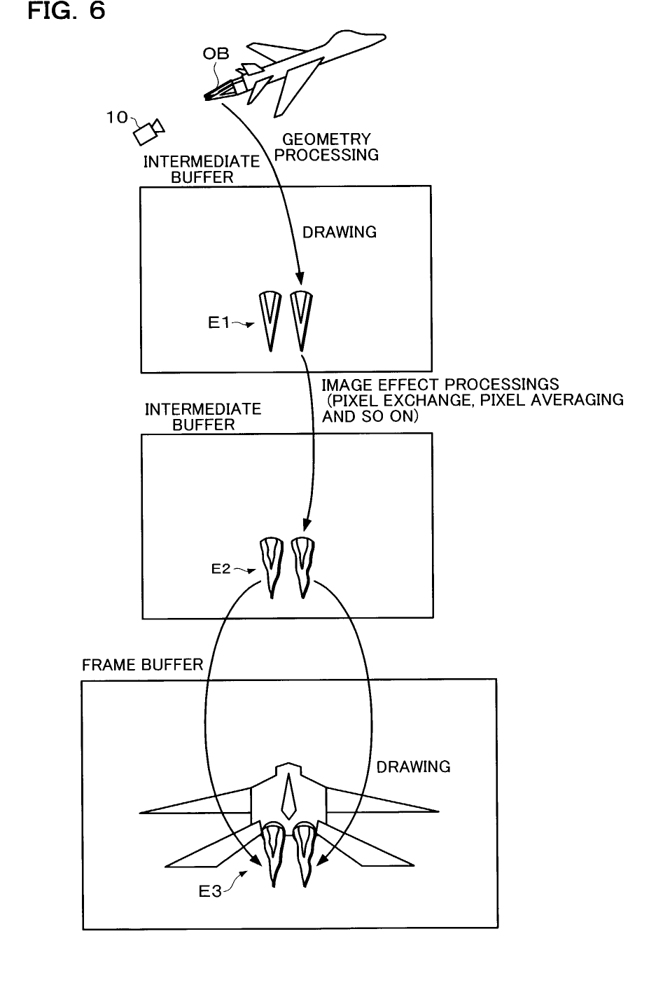

As shown by E1 in FIG. 6, the image of a geometry-processed object OB (flame) is first drawn in the intermediate buffer. As shown by E2, the drawn image in the intermediate buffer is subjected to an image effect processing such as pixel exchange, pixel (dot) averaging or the like. As shown by E3, the effect-processed image on the intermediate buffer is then drawn in the frame buffer.

In such a manner, flaring heat waves produced when the light is diffracted by the surrounding air heated by the flame to create an irregular distribution of air density can be represented.

In addition, for example, there may be considered such a technique that (M1) the image of an object is drawn in a frame buffer, (M2) the drawn image being read out from the frame buffer, (M3) the read image being then subjected to an image effect processing and (M4) the effect-processed image being re-drawn in the frame buffer.

However, such a technique requires four processings (M1), (M2), (M3) and (M4) as described.

On the contrary, this embodiment requires only three processings: (N1) the image of an object is drawn in the intermediate buffer; (N2) the drawn image in the intermediate buffer being then subjected to an image effect processing; and (N3) the effect-processed image being drawn in the frame buffer. Therefore, this embodiment can highly reduce the processing load in comparison with the aforementioned technique requiring four processings (M1), (M2), (M3) and (M4).

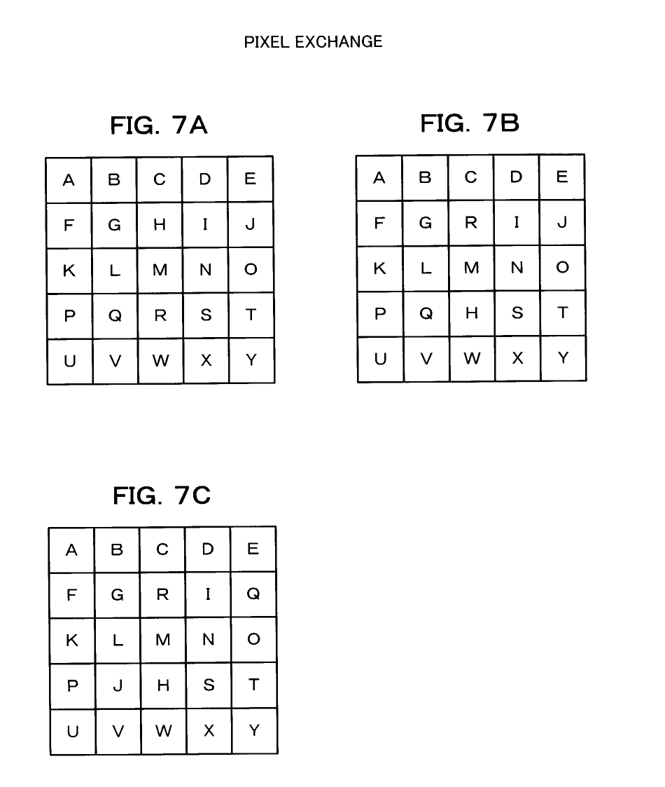

The pixel exchanging process exchanges the color information of any two pixels each other, as shown in FIGS. 7A, 7B and 7C. For example, in FIG. 7B, the color information of two pixels R and H are exchanged each other while in FIG. 7C, the color information of two pixels J and Q are exchanged each other. When the pixel exchanging is carried out as shown in FIGS. 7A, 7B and 7C, a pseudo-deflection of light can be represented.

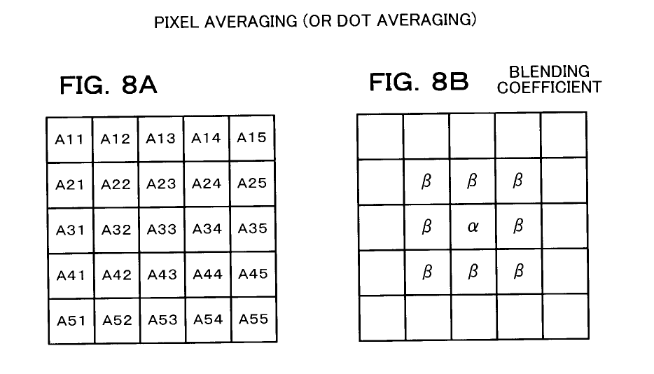

As shown in FIGS. 8A, 8B and 8C, the pixel averaging process blends the color information of a pixel (dot) with those of the surrounding pixels. For example, the color information of a pixel A33 is blended with the color information of the surrounding pixels A22, A23, A24, A32, A34, A42, A43 and A44. In other words, if it is assumed that the blending coefficient is set as shown in FIG. 8B, the color information of the pixel A33 is represent by the following formula:

A33=(α×A33+β×Q)/R

Q=(A22+A23+A24+A32+A34+A42+A43+A44)

R=α+8×β

When the aforementioned pixel averaging process is carried out for all the pixels, a defocused image can be represented.

In addition to the pixel averaging process and pixel exchanging process, the image effect processings may include any other suitable effect processing such as mosaic (tessellation) processing, brightness transforming or the like.

2.4 Image Synthesizing on the Intermediate Buffer

According to this embodiment, various image synthesizing (blending) processes may be carried out using the images on the intermediate buffer before they are re-drawn in the frame buffer.

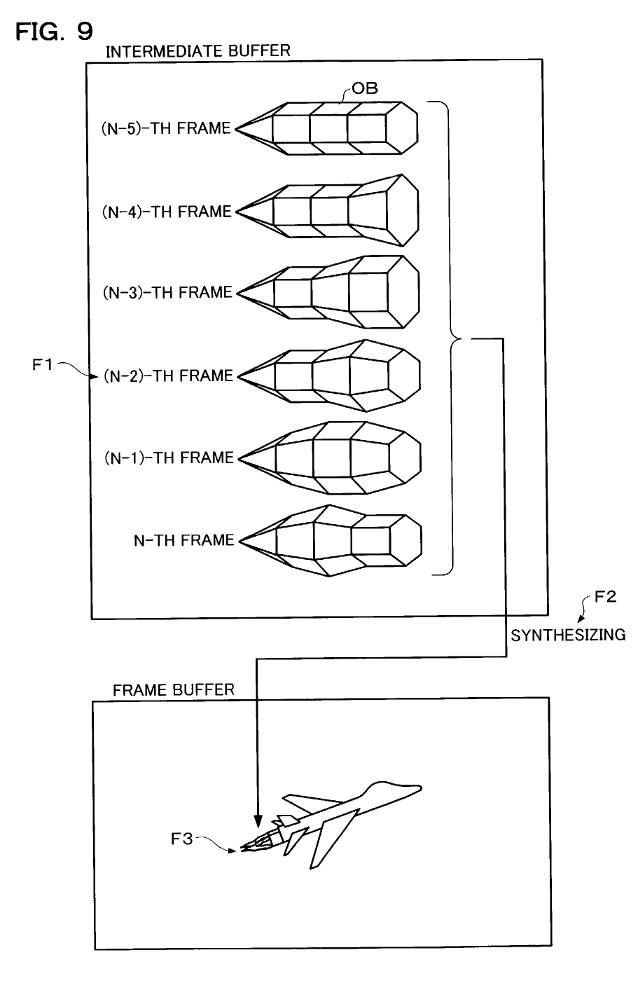

For example, FIG. 9 shows a change in shape (or animation) of an object (flame) based on the animation information. In this case, this embodiment has saved the images drawn in the intermediate buffer at the past frames (e.g., (N−5)-th through (N−1)-th frames) without clearing them, as shown by F1 in FIG. 9. The saved images at the past frames are synthesized with the image drawn in the intermediate buffer at the present frame (N-th frame), as shown by F2 in FIG. 9. The synthesized image is finally drawn in the frame buffer, as shown by F3.

In such a manner, the images at the past frames may be viewed to be afterimages. This can represent a flaring flame in a realistic manner.

When the images at the past frames are to be synthesized together, it is desirable that the image synthesizing process is made to increase the synthesizing ratio (e.g., α-value or the like) in the images at any frames nearer to the present frame. Although the images at the five past frames are saved in FIG. 9, the number of frames relating to the image to be saved is arbitrary.

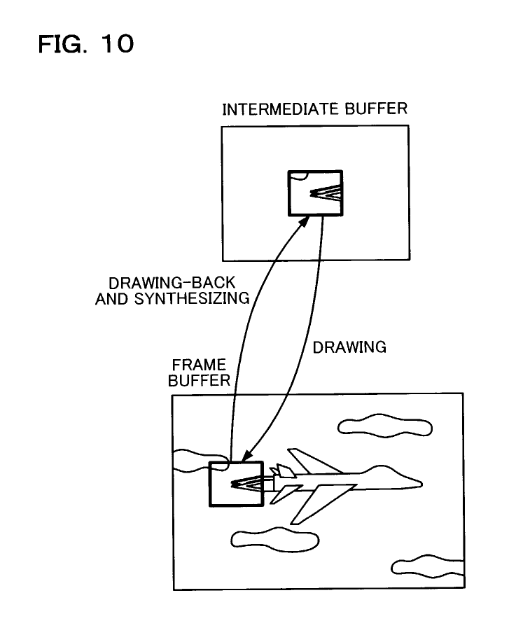

In FIG. 10, an image in the frame buffer (e.g., an image drawn at a directly previous frame) is drawn back to the intermediate buffer and blended with the image on the intermediate buffer, the synthesized image being drawn in the frame buffer.

If it is wanted to represent the heat waves in a flame in a realistic manner, it is desirable that the color information of a background (e.g., sky or the like) represented behind the flame is synthesized with the color information of the flame (e.g., α-synthesizing or the like) . If the image in the frame buffer is drawn back to the intermediate buffer wherein it is synthesized with the image in the intermediate buffer as shown in FIG. 10, a more realistic representation produced by synthesizing the color information of the background with that of the flame can be realized. If the image in the frame buffer is drawn back to the intermediate buffer and even when the background shown behind the flame is varying by the moving airplane, the image of the varying background can be synthesized with the image in the intermediate buffer. This enables a more realistic image to be represented.

2.5 Drawing to the Intermediate Buffer for Each of the Discrete Frames

In this embodiment, the image of the geometry-processed object is drawn in the intermediate buffer at the discrete (or decimated) frames. In other words, the image in the intermediate buffer is updated for each of the discrete frames, rather than at all the frames.

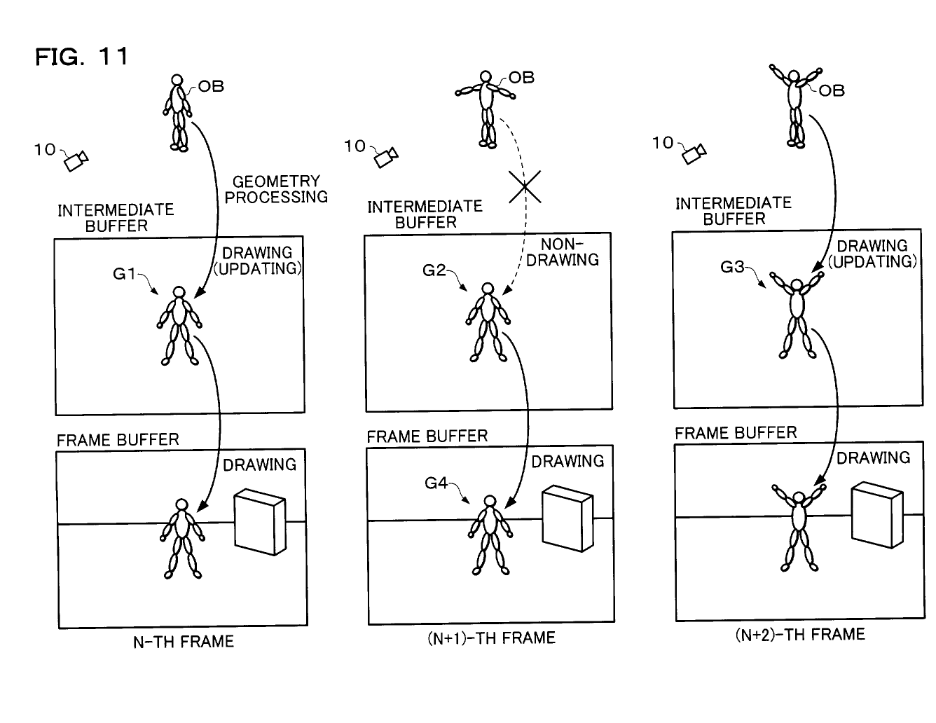

As shown by G1 and G3 in FIG. 11, for example, the image of a geometry-processed object OB is drawn in the intermediate buffer at the N-th and (N+2)-th frames to update the image in the intermediate buffer. On the other hand, as shown by G2, the image of the geometry-processed object OB will not be drawn in the intermediate buffer at the (N+1)-th frame. Thus, the image in the intermediate buffer will not be updated. The drawing of the object image from the intermediate buffer to the frame buffer is carried out for all the frames, but not particularly limited to this.

Therefore, the geometry-processing on the object OB and the drawing of the object image in the intermediate buffer are not required for all the frames. As a result, the processing load can highly be reduced.

Even at the (N+1)-th frame, for example, the image of the object OB can properly be displayed as shown by G4 in FIG. 11, because the image of the object OB at the N-th frame exists on the intermediate buffer.

Although FIG. 11 has been described to draw the image of the object OB in the intermediate buffer for each two-frame, the image of the object OB may be drawn in the intermediate buffer for each M-frame (M≧3). As M increases, the motion in the object OB will not be smoother, whereat the processing load for the geometry-processing and intermediate buffer drawing will be reduced.

Even if the drawing frames to the intermediate buffer are decimated as shown in FIG. 11, it is desirable that the drawing positions of the primitive surfaces on which the image of the intermediate buffer is mapped are updated for all the frames to provide the smooth motion to the object OB. In other words, the image of the intermediate buffer is mapped on the primitive surface while moving that primitive surface for each frame.

When it is wanted to draw the images of plural geometry-processed objects are drawn in the intermediate buffer, this embodiment may draw the image of the K-th object at the N-th frame and draw the image of the L-th object in the intermediate buffer at the (N+1)-th frame without drawing the image of the K-th object in the intermediate buffer.

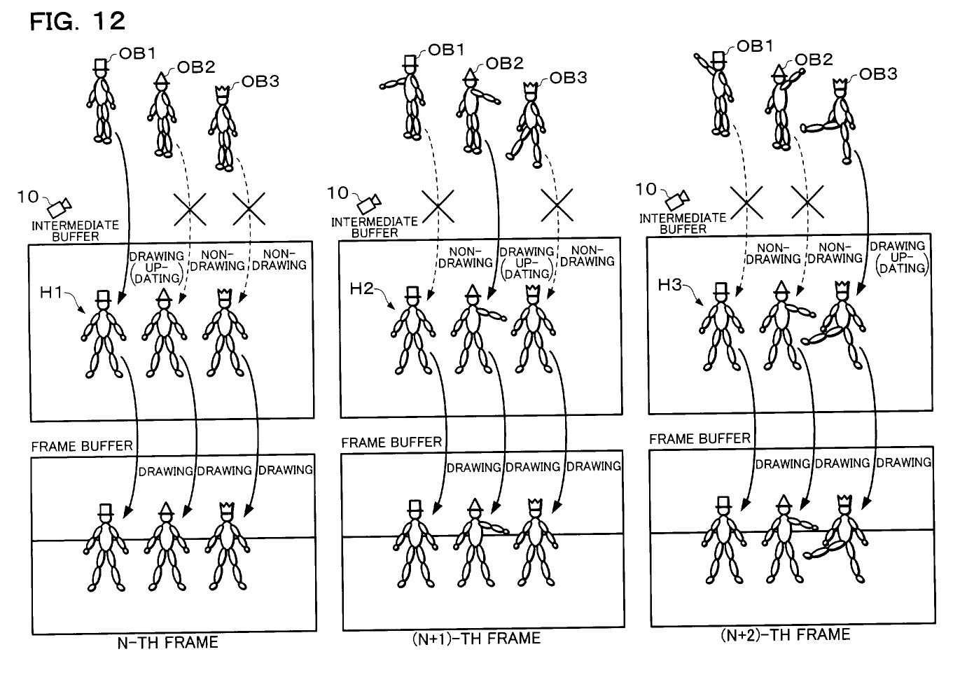

As shown by H1 in FIG. 12, for example, the image of a geometry-processed object OB1 may be drawn in the intermediate buffer at the N-th frame to update the image of OB1 in the intermediate buffer, but the images of the other objects OB2 and OB3 will not be drawn in the intermediate buffer not to update the images of OB2 and OB3 in the intermediate buffer.

As shown by H2 in FIG. 12, moreover, the image of the geometry-processed object OB2 is drawn in the intermediate buffer at the (N+1)-th frame, but the image of the other objects OB1 and OB3 will not be drawn in the intermediate buffer.

As shown by H3 in FIG. 12, additionally, the image of the geometry-processed object OB3 is drawn in the intermediate buffer at the (N+2)-th frame, but the images of the other objects OB1 and OB2 will not be drawn in the intermediate buffer.

In such a manner, even though a plurality of objects come on the scene, only one drawing to the intermediate buffer is required for each frame. Thus, there can be avoided such a defect that the drawing of objects will not be completed within one frame due to the increase of the number of the objects . Therefore, this embodiment can generate a game image which is optimal in such a sports game that a number of objects (or characters) come on the scene.

Although FIG. 12 has been described as to the intermediate buffer in which the image of only one object is to be drawn for each frame, the number of the objects images to be drawn in the intermediate buffer for each frame is arbitrary.

3. Processings in this Embodiment

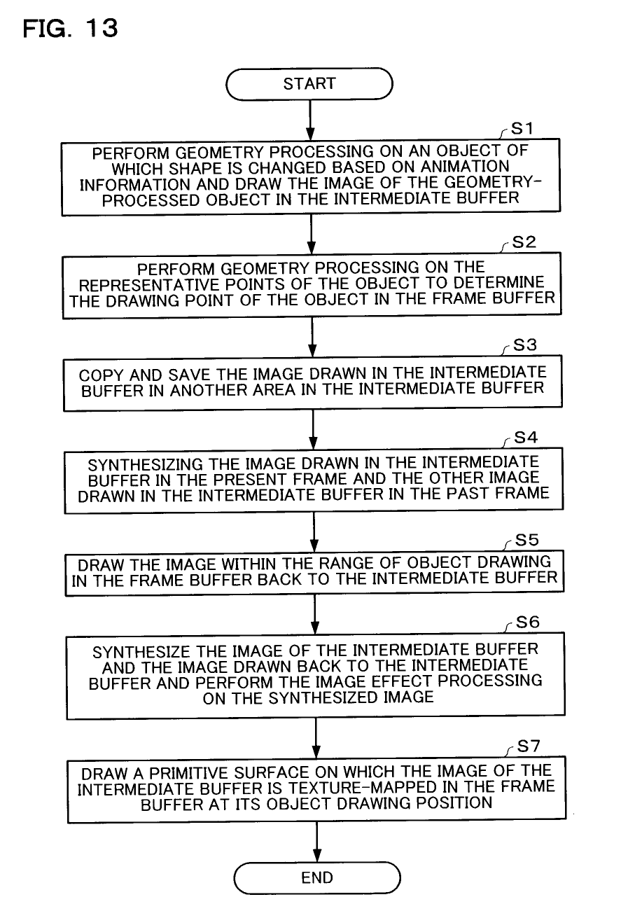

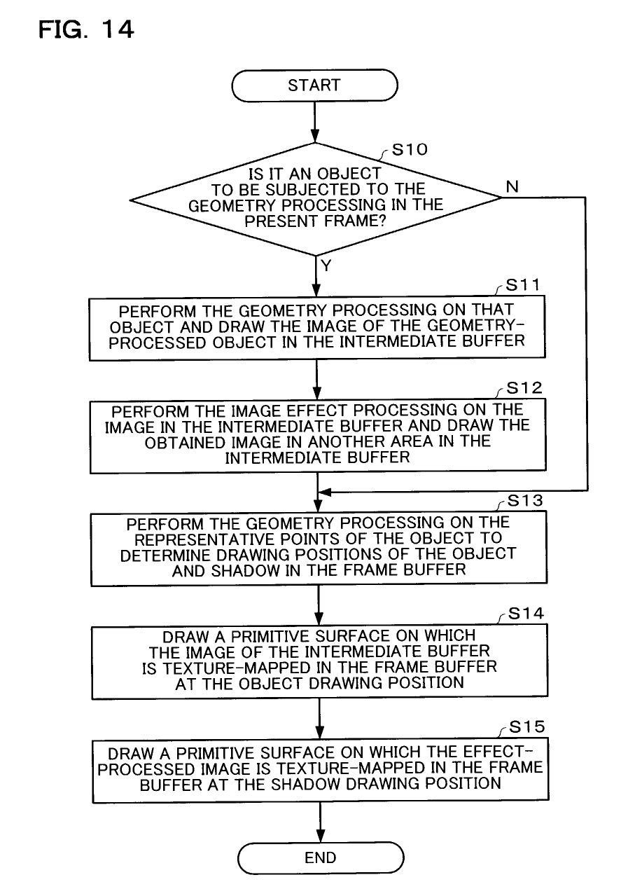

The details of the process according to this embodiment will be described using the flowcharts shown in FIGS. 13 and 14.

As described in connection with FIG. 9, an object of which shape is changed based on the animation information is first subjected to a geometry-processing. The image of this geometry-processed object is then drawn in the intermediate buffer (step S1).

The geometry-processing is made to the representative points of the object to determine the drawing position at which the object is to be drawn in the frame buffer (step S2).

The image drawn in the intermediate buffer is then copied and saved in the intermediate buffer at another area (step S3) . As described in connection with FIG. 9, the image drawn in the intermediate buffer at the present frame is then synthesized with the other images drawn in the intermediate buffer at the past frames (step S4).

As described in connection with FIG. 10, the image existing in the frame buffer within the range of object drawing is then drawn back to the intermediate buffer (step S5). The image in the intermediate buffer is synthesized with the image drawn back to the intermediate buffer. The synthesized image is then subjected to such an image effect processing as described in connection with FIGS. 6 to 8B (step S6).

As described in connection with FIG. 3, a primitive surface (or polygon) on which the image of the intermediate buffer is texture-mapped is drawn in the frame buffer at the object drawing position (or the position determined at the step S2) (step S7).

FIG. 14 is a flowchart illustrating the drawing of an image in the intermediate buffer for each of the discrete frames.

It is first judged whether or not an object to be processed is one to be subjected to the geometry-processing at the present frame (step S10). If it is judged that the object to be processed should be subjected to the geometry-processing, the geometry-processing is made to that object as described in connection with FIG. 12. The image of the geometry-processed object is then drawn in the intermediate buffer (step S11). As described in connection with FIG. 6, the image drawn in the intermediate buffer is then subjected to an image effect processing and drawn in the intermediate buffer at another area (step S12).

On the other hand, if the object to be processed is not one to be subjected to the geometry-processing at the present frame, the steps S11 and S12 are omitted, thus highly reducing the processing load.

Next, the representative points in the object are subjected to the geometry-processing to determine the object drawing position and the object shadow drawing position in the frame buffer (step S13). The image of the intermediate buffer is then texture-mapped on a primitive surface which is in turn drawn in the frame buffer at the object drawing position (step S14). As described in connection with FIG. 5, the image subjected to the image effect processing (or shadow generating) is then texture-mapped on another primitive surface which is in turn drawn in the frame buffer at the shadow drawing position (step S15). Thus, the shadow of the object can be displayed with reduced processing load.

4. Hardware Arrangement

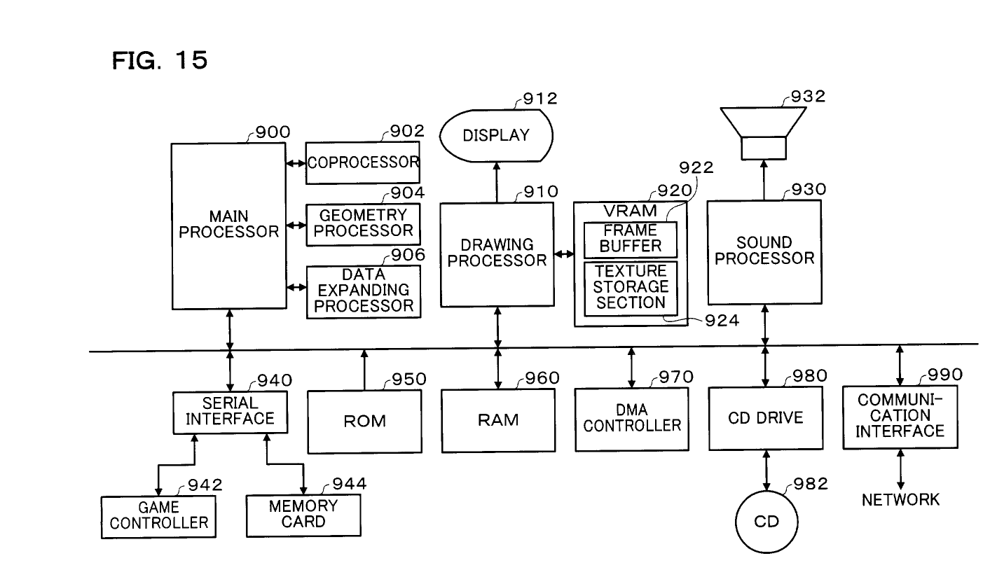

A hardware arrangement which can realize this embodiment is shown in FIG. 15.

A main processor 900 operates to execute various processings such as game processing, image processing, sound processing and other processings according to a program stored in a CD (information storage medium) 982, a program transferred through a communication interface 990 or a program stored in a ROM (information storage medium) 950.

A coprocessor 902 is to assist the processing of the main processor 900 and has a product-sum operator and analog divider which can perform high-speed parallel calculation to execute a matrix (or vector) calculation at high speed. If a physical simulation for causing an object to move or act (motion) requires the matrix calculation or the like, the program running on the main processor 900 instructs (or asks) that processing on the coprocessor 902.

A geometry processor 904 is to perform a geometry processing such as coordinate transformation, perspective transformation, light source calculation, curve formation or the like and has a product-sum operator and analog divider which can perform high-speed parallel calculation to execute a matrix (or vector) calculation at high speed. For example, for the coordinate transformation, perspective transformation or light source calculation, the program running on the main processor 900 instructs that processing on the geometry processor 904.

A data expanding processor 906 is to perform a decoding process for expanding image and sound compressed data or a process for accelerating the decoding process in the main processor 900. In the opening, intermission, ending or game scene, thus, an MPEG compressed animation may be displayed. The image and sound data to be decoded may be stored in the storage devices including ROM 950 and CD 982 or may externally be transferred through the communication interface 990.

A drawing processor 910 is to draw or render an object constructed by primitive surfaces such as polygons or curved faces at high speed. On drawing the object, the main processor 900 uses a DMA controller 970 to deliver the object data to the drawing processor 910 and also to transfer a texture to a texture storage section 924, if necessary. Thus, the drawing processor 910 draws the object in a frame buffer 922 at high speed while performing a hidden-surface removal by the use of a Z-buffer or the like, based on the object data and texture. The drawing processor 910 can also perform α-blending (or translucency processing), depth cueing, mip-mapping, fogging, bi-linear filtering, tri-linear filtering, anti-aliasing, shading and so on. As the image for one frame is written into the frame buffer 922, that image is displayed on a display 912.

A sound processor 930 includes any multi-channel ADPCM sound source or the like to generate high-quality game sounds such as BGMs, sound effects and voices. The generated game sounds are outputted from a speaker 932.

The operational data from a game controller 942, saved data from a memory card 944 and personal data may externally be transferred through a serial interface 940.

ROM 950 has stored a system program and so on. For an arcade game system, the ROM 950 functions as an information storage medium in which various programs have been stored. The ROM 950 may be replaced by any suitable hard disk.

RAM 960 is used as a working area for various processors.

The DMA controller 970 controls the DMA transfer between the processor and the memory (such as RAM, VRAM and ROM).

The DMA drive 980 drives a CD (information storage medium) 982 in which the programs, image data or sound data have been stored and enables these programs and data to be accessed.

The communication interface 990 is to perform data transfer between the image generating system and any external instrument through a network. In such a case, the network connectable with the communication interface 990 may take any of communication lines (analog phone line or ISDN) or high-speed serial bus. The use of the communication line enables the data transfer to be performed through the Internet. If the high-speed serial bus is used, the data transfer may be carried out between the image generating system and any other game system (or systems).

All the means of the present invention may be realized (or executed) only through hardware or only through a program which has been stored in an information storage medium or which is distributed through the communication interface. Alternatively, they may be realized (or executed) both through the hardware and program.

If all the means of the present invention are executed both through the hardware and program, the information storage medium will have stored a program for realizing the means of the present invention through the hardware. More particularly, the aforementioned program instructs the respective processors 902, 904, 906, 910 and 930 which are hardware and also delivers the data to them, if necessary. Each of the processors 902, 904, 906, 910 and 930 will realize the corresponding one of the means of the present invention based on the instruction and delivered data.

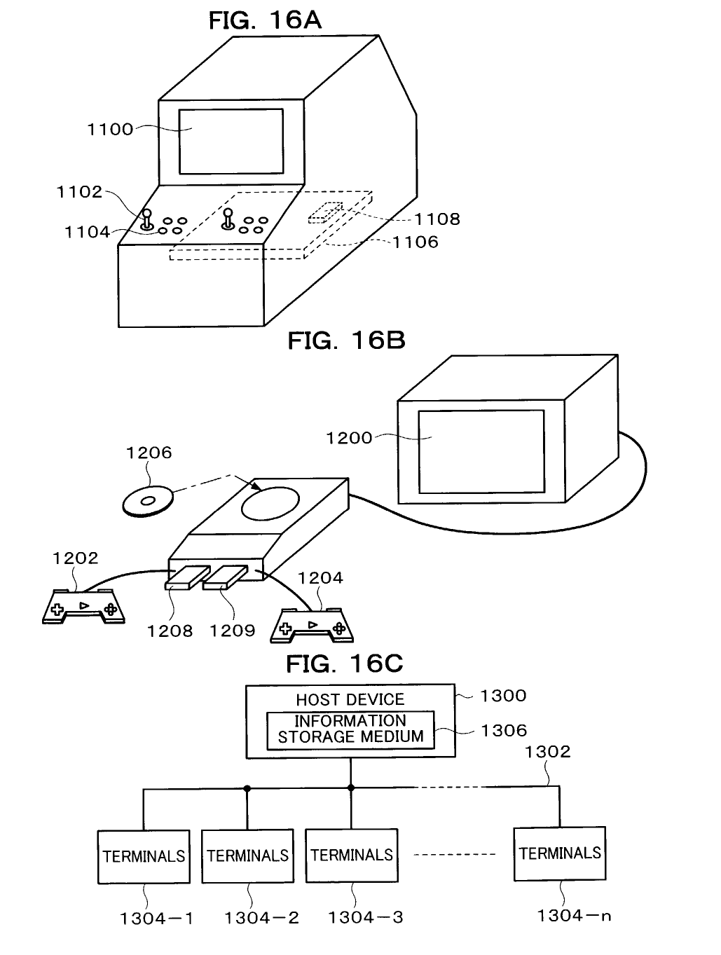

FIG. 16A shows an arcade game system to which this embodiment is applied. Players enjoy a game by controlling levers 1102 and buttons 1104 while viewing a game scene displayed on a display 1100. A system board (circuit board) 1106 included in the game system includes various processor and memories which are mounted thereon. Information (program or data) for realizing all the means of the present invention has been stored in a memory 1108 on the system board 1106, which is an information storage medium. Such information will be referred to “stored information” later.

FIG. 16B shows a home game apparatus to which this embodiment is applied. A player enjoys a game by manipulating game controllers 1202 and 1204 while viewing a game picture displayed on a display 1200. In such a case, the aforementioned stored information pieces have been stored in DVD 1206 and memory cards 1208, 1209 which are detachable information storage media in the game system body.

FIG. 16C shows an example wherein this embodiment is applied to a game system which includes a host device 1300 and terminals 1304-1 to 1304-n connected to the host device 1300 through a network (which is a small-scale network such as LAN or a global network such as INTERNET) 1302. In such a case, the above stored information pieces have been stored in an information storage medium 1306 such as magnetic disk device, magnetic tape device, semiconductor memory or the like which can be controlled by the host device 1300, for example. If each of the terminals 1304-1 to 1304-n are designed to generate game images and game sounds in a stand-alone manner, the host device 1300 delivers the game program and other data for generating game images and game sounds to the terminals 1304-1 to 1304-n. On the other hand, if the game images and sounds cannot be generated by the terminals in the stand-alone manner, the host device 1300 will generate the game images and sounds which are in turn transmitted to the terminals 1304-1 to 1304-n.

In the arrangement of FIG. 16C, the means of the present invention may be decentralized into the host device (or server) and terminals. The above information pieces for executing (or realizing) the respective means of the present invention may be distributed and stored into the information storage media of the host device (or server) and terminals.

Each of the terminals connected to the network may be either of home or arcade type. When the arcade game systems are connected to the network, it is desirable that each of the arcade game systems includes a portable information storage device (memory card or portable game machine) which can not only transmit the information between the arcade game systems but also transmit the information between the arcade game systems and the home game systems.

The present invention is not limited to the things described in connection with the above forms, but may be carried out in any of various other forms.

For example, the invention relating to one of the dependent claims may not contain part of the structural requirements in any claim to which the one dependent claim belongs. The primary part of the invention defined by one of the independent claim may be belonged to any other independent claim.

This embodiment takes a technique of drawing, in the frame buffer, the primitive surface on which the image of the intermediate buffer is texture-mapped to draw the image of the intermediate buffer in the frame buffer. The present invention is not limited to such a technique, but may similarly be applied to such a technique that the image of the intermediate buffer is drawn directly in a given drawing area on the frame buffer.

The image effect processing according to the present invention is not limited to one as described in connection with FIGS. 6 to 8B, but may be carried out in any of various other forms.

In the invention in which the image of the object is drawn in the intermediate buffer for each of the discrete frames, it is sufficient that the frames to be drawn are discrete. It is arbitrary at which frame the image of the object should be drawn in the intermediate buffer.

The present invention may similarly be applied to any of various other games such as fighting games, shooting games, robot combat games, sports games, competitive games, roll-playing games, music playing games, dancing games and so on.

Furthermore, the present invention can be applied to various game systems (or image generating systems) such as arcade game systems, home game systems, large-scaled multi-player attraction systems, simulators, multimedia terminals, game image generating system boards and so on.

1. A game system performing image generation, comprising:
intermediate buffer drawing means which temporarily draws an image of a geometry-processed object in an intermediate buffer in place of drawing the image in a frame buffer; and
frame buffer drawing means for drawing the image of the geometry-processed object drawn in the intermediate buffer from the intermediate buffer into the frame buffer.

2. The game system according to claim 1,
wherein into the frame buffer, the frame buffer drawing means draws a primitive surface of which drawing positions is specified based on three-dimensional information of the object and on which the image of the geometry-processed object drawn in the intermediate buffer is texture-mapped.

3. The game system according to claim 2,
wherein when a plurality of primitive surfaces corresponding to a plurality of objects are to be drawn into the frame buffer, the frame buffer drawing means performs hidden-surface removal between the primitive surfaces based on the depth values of the respective primitive surfaces.

4. The game system according to claim 2,
wherein the frame buffer drawing means draws a plurality of primitive surfaces of which drawing positions are specified based on the three-dimensional information of one object into the frame buffer, and makes images texture-mapped over the plurality of primitive surfaces different from one another.

5. The game system according to claim 1, further comprising means for performing a given image effect processing on the image on the intermediate buffer before the image drawn in the intermediate buffer is drawn in the frame buffer.

6. The game system according to claim 1, further comprising means for synthesizing an image drawn in the intermediate buffer at a present frame with another image drawn in the intermediate buffer at a past frame before the image drawn in the intermediate buffer is drawn in the frame buffer.

7. The game system according to claim 1, further comprising means for synthesizing an image drawn in the intermediate buffer with another image drawn in the frame buffer before the image drawn in the intermediate buffer is drawn in the frame buffer.

8. The game system according to claim 1,
wherein the intermediate buffer drawing means draws the image of the geometry-processed object in the intermediate buffer for each discrete frame.

9. The game system according to claim 8,
wherein when the images of plural geometry-processed objects are drawn in the intermediate buffer, the intermediate buffer drawing means draws an image of the K-th object in the intermediate buffer at the N-th frame and draws an image of the L-th object in the intermediate buffer at the (N+1)-th frame without drawing the image of the K-th object in the intermediate buffer.

10. A computer-usable program embodied on an information storage medium or in a carrier wave, the program comprising a processing routine for a computer to realize:
intermediate buffer drawing means which temporarily draws an image of a geometry-processed object in an intermediate buffer in place of drawing the image in a frame buffer; and
frame buffer drawing means for drawing the image of the geometry-processed object drawn in the intermediate buffer from the intermediate buffer into the frame buffer.

11. The program according to claim 10,
wherein into the frame buffer, the frame buffer drawing means draws a primitive surface of which drawing positions is specified based on three-dimensional information of the object and on which the image of the geometry-processed object drawn in the intermediate buffer is texture-mapped.

12. The program according to claim 11,
wherein when a plurality of primitive surfaces corresponding to a plurality of objects are to be drawn into the frame buffer, the frame buffer drawing means performs hidden-surface removal between the primitive surfaces based on the depth values of the respective primitive surfaces.

13. The program according to claim 11,
wherein the frame buffer drawing means draws a plurality of primitive surfaces of which drawing positions are specified based on the three-dimensional information of one object into the frame buffer, and makes images texture-mapped over the plurality of primitive surfaces different from one another.

14. The program according to claim 10, further comprising a processing routine for a computer to realize means for performing a given image effect processing on the image on the intermediate buffer before the image drawn in the intermediate buffer is drawn in the frame buffer.

15. The program according to claim 10, further comprising a processing routine for a computer to realize means for synthesizing an image drawn in the intermediate buffer at a present frame with another image drawn in the intermediate buffer at a past frame before the image drawn in the intermediate buffer is drawn in the frame buffer.

16. The program according to claim 10, further comprising a processing routine for a computer to realize means for synthesizing an image drawn in the intermediate buffer with another image drawn in the frame buffer before the image drawn in the intermediate buffer is drawn in the frame buffer.

17. The program according to claim 10,
wherein the intermediate buffer drawing means draws the image of the geometry-processed object in the intermediate buffer for each discrete frame.

18. The program according to claim 17,
wherein when the images of plural geometry-processed objects are drawn in the intermediate buffer, the intermediate buffer drawing means draws an image of the K-th object in the intermediate buffer at the Nth frame and draws an image of the L-th object in the intermediate buffer at the (N+1)-th frame without drawing the image of the K-th object in the intermediate buffer.

19. An image generation method for generating an image, comprising steps of:
temporarily drawing an image of a geometry-processed object in an intermediate buffer in place of drawing the image in a frame buffer; and
drawing the image of the geometry-processed object drawn in the intermediate buffer from the intermediate buffer into the frame buffer.

20. The image generation method according to claim 19,
wherein a primitive surface, of which drawing positions is specified based on three-dimensional information of the object and on which the image of the geometry-processed object drawn in the intermediate buffer is texture-mapped, is drawn into the frame buffer.

21. The image generation method according to claim 20,
wherein when a plurality of primitive surfaces corresponding to a plurality of objects are to be drawn into the frame buffer, hidden-surface removal between the primitive surfaces is performed based on the depth values of the respective primitive surfaces.

22. The image generation method according to claim 20,
wherein a plurality of primitive surfaces of which drawing positions are specified based on the three-dimensional information of one object are drawn into the frame buffer, and images texture-mapped over the plurality of primitive surfaces are different from one another.

23. The image generation method according to claim 19,
wherein a given image effect processing on the image on the intermediate buffer is performed before the image drawn in the intermediate buffer is drawn in the frame buffer.

24. The image generation method according to claim 19,
wherein an image drawn in the intermediate buffer at a present frame is synthesized with another image drawn in the intermediate buffer at a past frame before the image drawn in the intermediate buffer is drawn in the frame buffer.

25. The image generation method according to claim 19,
wherein an image drawn in the intermediate buffer is synthesized with another image drawn in the frame buffer before the image drawn in the intermediate buffer is drawn in the frame buffer.

26. The image generation method according to claim 19,
wherein the image of the geometry-processed object in the intermediate buffer is drawn for each discrete frame.

27. The image generation method according to claim 26
wherein when the images of plural geometry-processed objects are drawn in the intermediate buffer, an image of the K-th object in the intermediate buffer is drawn at the N-th frame and an image of the L-th object in the intermediate buffer is drawn at the (N+1)-th frame without drawing the image of the K-th object in the intermediate buffer.
